(19) United States
(12) Patent Application Publication
(10) Pub. No.: US 2004/0041906 A1
(43) Pub. Date: Mar. 4, 2004

(54) Method for producing a real-time, moving, stereoscopic, preview image

(76) Inventor: Theodoric Benjamin Fruit, Ellsworth, WI (US)

Correspondence Address: THEODORIC BENJAMIN FRUIT, W3971 US HWY 10, ELLSWORTH, WI, 54011, US

(21) Appl. No.: 10/234,020

(22) Filed: Sep. 4, 2002

(51) Int. Cl. H04N 13/02; H04N 15/00

(52) U.S. Cl. 348/50

(57) ABSTRACT

The disclosed invention is a method for producing a real-time, moving, stereoscopic, preview image of the static, stereoscopic image that is being composed by the user. The disclosed invention will function by way of camera hardware and camera software conjunctionally performing steps that will use a static image and a real-time, moving image to produce the preview image. The preview image will allow the user to determine the three-dimensional appearance produced by altering the apparent displacement of photographic objects. Thus, the disclosed invention will allow for static, stereoscopic image creation by way of a single lens attached to a single camera positioned at user-determined spatial points. It is required that the camera has the ability to acquire, store and display electronic images.

### BACKGROUND OF THE INVENTION

The present invention relates to the field of stereoscopic photography; more specifically to a method which allows the user to affordably produce static, stereoscopic images with a single lens attached to a single camera.

Some of the past inventions for producing static, stereoscopic images require specially-designed hardware. For example, one invention requires the use of a specially-designed camera body that allows for the use of two lenses. The previously mentioned invention becomes very expensive due to the fact that two lenses must be used as well as a specially-designed camera body. Also, due to physical limitations, the previously mentioned invention can only provide the user with a very small range of lens separations; or a single lens separation alone. In another example, one invention requires the use of a specially-designed camera mount that is used to ensure that the camera alignment for the second-eye image remains true to the camera alignment for the first-eye image. The previously mentioned invention requires the user to buy extra hardware yet still provides the user with no guarantee that the results will be as the user expects. Also, due to physical limitations, the previously mentioned invention can only provide the user with a very small range of lens displacements.

All of the inventions mentioned above, as well as some that were not mentioned, require expensive hardware additions and/or expensive hardware modifications. Thus, they will cause significantly increased expenses for the consumer and, in many cases, the camera manufacturer.

### BRIEF SUMMARY OF THE INVENTION

The disclosed invention will produce a real-time, moving, stereoscopic, preview image of the static, stereoscopic image that is being composed by the user. The disclosed invention will function by way of camera hardware and camera software conjunctionally performing steps that will use a static image and a real-time, moving image to produce the preview image. The preview image will allow the user to alter the apparent displacement of photographic objects while simultaneously determining the three-dimensional appearance produced by their alterations. Thus, the disclosed invention will allow for static, stereoscopic image creation by way of a single lens attached to a single camera positioned at user-determined spatial points. It is required that the camera has the ability to acquire, store and display electronic images.

The disclosed invention is intended to allow the user, who requires little or no previous experience in the field of stereoscopic photography, to affordably produce static, stereoscopic images with great ease and accuracy while using a single lens attached to a single camera. These are some advantages over many past inventions.

The disclosed invention is further intended to allow the user to use a very large range of lens displacements to produce static, stereoscopic images of many different sizes of objects. For example, a camera which utilizes the disclosed invention will allow the user to use a lens displacement of one inch to produce a static, stereoscopic image of a small subject, such as a flower petal. The same camera will allow the user to use a lens displacement of one quarter of a mile to produce a static, stereoscopic image of a very large subject, such as a mountain range. This is another advantage over many past inventions.

The disclosed invention does not require expensive hardware additions nor does it require expensive hardware modifications. Thus, the expense of the disclosed invention will be considerably less than past inventions. The reduction in expenses is another intention and advantage of the disclosed invention.

### DETAILED DESCRIPTION OF THE INVENTION

Throughout this specification, terms such as “first eye” have been used. The eye that will be referred to as “first eye” is determined by camera motion. If the user moves the camera from left to right while the preview image is being produced, then “first eye” would refer to the user's left eye. Thus, the term “first-eye image” refers to the image that will be displayed exclusively to the user's first eye.

In the preferred embodiment of the invention, the preview image will be produced by camera hardware and camera software conjunctionally performing the following steps. Step 1: acquire a static image from the electronic image acquiring device when a user-effected event has occurred, such as the shutter-release button being pressed. Step 2: begin a cycle that will continuously repeat steps 3 through 4 until a user-effected event has occurred, such as the shutter-release button being pressed a second time. Step 3: acquire a static image from the electronic image acquiring device. Step 4: display the image acquired in step 1 exclusively to the user's first eye and simultaneously display the image acquired in step 3 exclusively to the users second eye. The purpose of the cycle created in step 2 is to cause the second-eye image (acquired in step 3) to be continuously updated. After each time the second-eye image has been updated, step 4 will display the secondeye image in simultaneity with the first-eye image (acquired in step 1). Thus, a real-time, moving, stereoscopic, preview image will be produced.

Color filtering is one method that may be used to display certain images exclusively to certain eyes. The following is one example of how this method can be used to produce the preview image. The static, first-eye image will be displayed using red light. The moving, second-eye image should be displayed using a color of light opposing the color of light used to display the static, first-eye image. Thus, the moving, second-eye image should be displayed using green and blue or cyan light (combining green and blue light produces cyan light, the opposite of red light). According to this example, to properly perceive spatial depth in the preview image, the user should wear glasses with a red-colored filter for their first eye and a cyan-colored filter for their second eye. Thus, any image displayed using red light will be visible exclusively to the user's first eye and any image displayed using cyan light will be visible exclusively to the user's second eye.

In other embodiments of the invention, other methods may be used to display certain images exclusively to certain eyes, such as the green/magenta or blue/yellow color filtering methods, the electronic shutter method, or the light polarization method.

The following steps are one example of how the disclosed invention may be used. Step 1: place the camera in the desired position of the static, first-eye image. Step 2: acquire the static, first-eye image. Step 3: re-position the camera while simultaneously viewing the real-time, moving, stereoscopic, preview image. Step 4: acquire the static, second-eye image when the preview image displays satisfactory results.

What I claim as my invention is:

1. A method for producing a real-time, moving, stereoscopic, preview image to allow the user to determine the three-dimensional appearance produced by altering the apparent displacement of photographic objects thus allowing for static, stereoscopic image creation by way of a single lens attached to a single camera positioned at user-determined spatial points, said camera requiring the ability to acquire, store and display electronic images.

2. A method according to claim 1 wherein said preview image will be produced by camera software and camera hardware conjunctionally performing the following steps:
a. acquire static image from electronic image acquiring device when a user-effected event has occurred;
b. cycle steps [c] through [d] until a user-effected event has occurred;
c. acquire static image from electronic image acquiring device;
d. display the image acquired in step [a] exclusively to user's left eye and simultaneously display the image acquired in step [c] exclusively to user's right eye.

3. A method according to claim 1 wherein said preview image will be produced by camera software and camera hardware conjunctionally performing the following steps:
a. acquire static image from electronic image acquiring device when a user-effected event has occurred;
b. cycle steps [c] through [d] until a user-effected event has occurred;
c. acquire static image from electronic image acquiring device;
d. display the image acquired in step [a] exclusively to user's right eye and simultaneously display the image acquired in step [c] exclusively to user's left eye.

4. A method according to claim 1 wherein said preview image will be produced by camera software and camera hardware conjunctionally performing the following steps:
a. acquire static image from electronic image acquiring device when a user-effected event has occurred;
b. cycle steps [c] through [d] until a user-effected event has occurred;
c. acquire static image from electronic image acquiring device;
d. display the image acquired in step [a] exclusively to user's left eye and alternately display the image acquired in step [c] exclusively to user's right eye.

5. A method according to claim 1 wherein said preview image will be produced by camera software and camera hardware conjunctionally performing the following steps:
a. acquire static image from electronic image acquiring device when a user-effected event has occurred;
b. cycle steps [c] through [d] until a user-effected event has occurred;
c. acquire static image from electronic image acquiring device;
d. display the image acquired in step [a] exclusively to user's right eye and alternately display the image acquired in step [c] exclusively to users left eye.

6. A method according to claim 1 wherein said preview image will be produced by camera software and camera hardware conjunctionally performing the following steps:
a. acquire static image from electronic image acquiring device when a user-effected event has occurred;
b. cycle steps [c] through [d] until a user-effected event has occurred;
c. acquire static image from electronic image acquiring device;
d. display the image acquired in step [c] exclusively to user's right eye and alternately display the image acquired in step [a] exclusively to users left eye.

7. A method according to claim 1 wherein said preview image will be produced by camera software and camera hardware conjunctionally performing the following steps:
a. acquire static image from electronic Image acquiring device when a user-effected event has occurred;
b. cycle steps [c] through [d] until a user-effected event has occurred;
c. acquire static image from electronic image acquiring device;
d. display the image acquired in step [c] exclusively to user's left eye and alternately display the image acquired in step [a] exclusively to user's right eye.

8. A method according to claim 1 wherein said preview image will be produced by camera software and camera hardware conjunctionally performing the following steps:
a. acquire static image from electronic image acquiring device when a user-effected event has occurred;
b. display the image acquired in step [a] exclusively to user's left eye;
c. cycle steps [d] through [e] until a user-effected event has occurred;
d. acquire static image from electronic image acquiring device;
e. display the image acquired in step [d] exclusively to user's right eye.

9. A method according to claim 1 wherein said preview image will be produced by camera software and camera hardware conjunctionally performing the following steps:
a. acquire static image from electronic image acquiring device when a user-effected event has occurred;
b. display the image acquired in step [a] exclusively to users right eye;
c. cycle steps [d] through [e] until a user-effected event has occurred;
d. acquire static image from electronic image acquiring device;
e. display the image acquired in step [d] exclusively to user's left eye.
